(19) United States
(12) Patent Application Publication
(10) Pub. No.: US 2010/0099066 A1
(43) Pub. Date: Apr. 22, 2010

(54) Surgical Training System and Model With Simulated Neural Responses and Elements

(75) Inventors: David A. Mire, Cordova, TN (US); Jeffrey H Nycz, Warsaw, IN (US); William Keith Adcox, Memphis (TN); Stanley W. Olson, JR., Germantown, TN (US); Joseph J. Saladino, Memphis, TN (US)

Correspondence Address: MEDTRONIC;Attn: Noreen Johnson - IP Legal Department, 2600 Sofamor Danek Drive, MEMPHIS, TN, 38132, US

(73) Assignee: WARSAW ORTHOPEDICS, INC., Warsaw, IN (US)

(21) Appl. No.: 12/255,014

(22) Filed: Oct. 21, 2008

(51) Int. Cl. G09B 23/28

(52) U.S. Cl. 434/272; 434/274

(57) ABSTRACT

A training apparatus, model, system, and method are disclosed that allows any trainee to train to perform surgeries in areas of the human body that include one or more nerves. The training model is configured to mimic one or more areas of the human anatomy in which the procedure is going to be performed that contains nerves by providing a realistic anatomical model of the area of interest. A neural element is positioned in the anatomical area of interest that is configured to behave like a real nerve. A neural monitoring system is utilized to ensure that while using specially designed surgical tools or devices during the procedure, the surgeon is trained to avoid taking actions that would adversely affect the functionality of the nerves located in this area after the surgery.

### CROSS REFERENCE TO RELATED PATENTS/APPLICATIONS

This application contains subject matter which is related to the subject matter of the following commonly owned patent, published applications, and pending applications, which are hereby incorporated herein by references in their entirety:

“Artificial Bone,” by Mike Zeeff, U.S. Letters Pat. No. 7,018,212 B2, issued Mar. 28, 2006;

“Soft Tissue Model,” by Mike Zeeff, U.S. Ser. No. 10/936,214, filed Sep. 8, 2004, published on Mar. 9, 2006 as U.S. Patent Application Publication No. US 2006/0051729 A1;

“Electrically Insulated Surgical Probing Tool,” by Seth L. Neubardt, and Sharonda Felton, published on Aug. 3, 2006 as U.S. Patent Application Publication No. US 2006/0173374 A1; and

“Surgical Training Model and Method for Use in Facilitating Training of a Surgical Procedure,” by Hank F. Pellegrin, Jr., and Chad E. Maxwell filed on May 29, 2007, and assigned U.S. application Ser. No.: 11/754,788, which is a continuation of U.S. application Ser. No.: 11/608,308, filed on Dec. 8, 2006.

### TECHNICAL FIELD

The present invention relates generally to medical practitioner training aids, and more specifically, but not exclusively, to a surgical training model and system comprising an insert device having one or more simulated neural elements or nerves and a holder mechanism configured to simulate one or more surgical procedures utilizing neural monitoring.

### BACKGROUND

Anatomical reproductions and models are being utilized to replace or supplement cadaver specimens for the surgical training of medical practitioners. The demand to practice surgical techniques and to evaluate the use of new surgical approaches, techniques and implants is increasingly important in the evolving medical field. Typically, medical practitioners have used cadavers or alternatively, saw-bone models to practice the access, delivery and implantation of medical devices. The limited supply and logistical challenges of cadaver specimens and the high costs associated with the respectful care and disposal of used human specimens challenges the ability of educational companies, courses and institutions to meet the demand.

The alternative saw-bone models have been used increasingly to display newly developed implant devices and on which to perform practice surgical procedures. The associated low cost and ease of ordering these types of models provides the medical practitioner with an attractive alternative. The disadvantages of saw-bone models are their lack of realistic anatomic features and soft-tissue characteristics as well as the inability of these devices to simulate neural and other tissue responses during medical interventions and surgical procedures.

### SUMMARY

One illustrative form of the present application discloses a surgical training device or apparatus that includes an artificial bone portion and an artificial soft-tissue portion that are configured to mimic at least a portion of an anatomy of a mammal. A neural element is positioned in relation to the artificial bone structure and the artificial soft-tissue structure to mimic one or more nerves that may be present in the portion of the anatomy of the mammal. In addition, the neural elements are operable to provide electric signals indicative of a response to stimulation. The stimulation is provided by a surgical device or tool that either comes into contact with the neural element or gets within a predetermined distance of the neural element.

Based on proximity and/or insult, the simulated neural element may be provoked in a manner comprehensible to the trainee and can have a range of programmed sensitivities, each to uniquely respond, suggesting either a range of proximity and/or the degree of the transient or enduring iatrogenic insult. The neural or tissue response observed may include but not be limited to direct observation and/or auditory/tactile/visual cues from a local or distant monitor or the local training instrument/implant used. Stimulation of neural and tissue elements may be due to mechanical pressures, changes in anatomical positions or elevations and/or reflection and retraction, changes or disruption or severance of electrical (neural) continuity, changes in pulsatile or other fluid dynamics and changes in temperature.

Another representative form of the present application discloses a surgical training model that includes a holder member having a receptacle portion. The holder member is configured to mimic a portion of an anatomy of a mammal, which is disclosed herein as a human. An insert member is configured to be positioned within the receptacle portion of the holder member. The insert member includes an artificial bone portion and an artificial soft-tissue portion that mimic the internal structural elements located in the portion of anatomy represented by the holder member. A neural element is oriented to mimic one or more nerves located in the portion of the anatomy of the mammal. The neural element is configured to generate an electric signal in response to a stimulus, which is provided by a surgical tool.

Yet another representative form of the present application discloses a surgical training system. The surgical training system includes an anatomical surgical training model having an artificial bone portion and an artificial soft-tissue portion surrounding at least a portion of the artificial bone portion. As with the other forms, the artificial bone portion and the artificial soft-tissue portion are configured to mimic a portion of an anatomy of a mammal. A neural element is oriented or positioned in relation to the artificial bone portion and the artificial soft-tissue portion to simulate nerves located in the portion of the anatomy of the mammal. A surgical device is operable to cause the neural element to generate an output signal in response to the presence of the surgical device. The output signal is indicative of an output that would be generated by a nerve. A processing unit is connected with the neural element for receiving the output signal and is responsible for generating an indicator that can be processed by the surgeon, such as a graphical representation on a display, a light emitting diode, an audible warning, or a tactile vibratory warning.

Another aspect of the present application discloses a method of training a surgeon to perform a surgical procedure in areas of the body that contain nerves. The training method includes providing an anatomical surgical training model having an artificial bone portion and an artificial soft-tissue portion surrounding at least a portion of said artificial bone portion. The artificial bone portion and the artificial soft-tissue portion are configured to mimic a portion of an anatomy of a mammal. One or more neural elements are provided that are configured to mimic nerves located in the portion of the anatomy of the mammal. A surgical device is provided that is operable to cause the neural element to generate a signal in response to the detection of the presence of the surgical device. In response to the signal that is generated in response to detection of the presence of the surgical device, an indicator is generated that is comprehensible by the trainee.

Anatomical models, implants and instruments used in training events that may contribute to comprehensive preoperative planning may be incrementally instrumented with complementary sensors and RFID devices with a capacity to contribute to an accurate, educational “bill of materials” (“BOM”). These sensors and RFID devices log sequence and devices and instruments for all interventional therapies and processes employed. To the extent that a training event should be reproduced clinically, each may be itemized and captures to assure that all necessary and alternate technologies that should be available and/or used are present in the clinical execution of the plan. In this way, a positive and constructive training event the sensed or logged BOM can serve as a checklist and/or protocol. In that way, the BOM prepares and assures the operator, operator team and hospital and suppliers alike that they are capable to clinically reproduce the training event's rehearsed intervention.

Further, additional features and advantages are realized through the techniques of the present invention. Other embodiments and aspects of the invention are described in detail herein and are considered a part of the claimed invention.

### BRIEF DESCRIPTION OF THE FIGURES

The figures are not necessarily to scale, emphasis instead being placed upon illustrating the principles of the invention. Moreover, in the figures, like reference numerals designate corresponding parts throughout the different views.

FIG. 1 is a block diagram of a simulated neural monitoring system.

FIG. 2 is a perspective view of an illustrative surgical tool utilized with the simulated neural monitoring system of FIG. 1;

FIG. 3 is an exploded, perspective view of an insert member and holder member prior to the insert member being placed within the receptacle portion of the holder member;

FIG. 4 is a lateral, elevational view of the insert member of FIG. 3, showing the assembled artificial bone portion and the artificial soft tissue portion;

FIG. 4A is a close-up view of a representative intervertebral disc portion of the artificial bone portion set forth in FIG. 4;

FIG. 5 is a perspective view of one representative form of a holder member of an anterior cervical surgical training model;

FIG. 6 is an anterior, perspective view of the holder member of the anterior cervical surgical training model of FIG. 5 showing a skin flap removed and exposing an outer muscle layer of an artificial soft tissue portion of an insert member;

FIG. 7 is an anterior, perspective view of the insert member coupled to a cradle for the anterior cervical surgical training model of FIG. 4;

FIG. 8 is an anterior, perspective view of the cradle showing the corresponding concavities that mate with an artificial bone portion and artificial soft tissue portion of the insert member for the anterior cervical training model;

FIG. 9 is an exploded, perspective view of the anterior cervical surgical training model with the cradle, insert member and holder member of FIG. 4, prior to the insert member being coupled to the cradle and then, being placed within a receptacle portion of the holder member;

FIG. 10 is an inferior, perspective view of one embodiment of a holder member of an anterior lumbosacral surgical training model with a skin flap in place;

FIG. 11 is an inferior, perspective view of the holder member of the anterior lumbosacral surgical training model of FIG. 9 showing a skin flap removed and exposing a vascular element of an artificial soft tissue portion of an insert member;

FIG. 12 is an exploded, perspective view of the anterior lumbosacral surgical training model with the cradle, insert member and holder member of FIG. 9, prior to the insert member being coupled to the cradle and then, being placed within a receptacle portion of the holder member;

FIG. 13 is a posterior, elevational view of a pelvis, ribs and an abnormally laterally curved spinal column that may be replicated by a pathology structure;

FIG. 14 is a perspective view of an insert member having a plurality of neural elements configured and arranged to mimic nerves;

FIG. 15 illustrates a representative simulation of a plurality of neural elements; and

FIG. 16 illustrates a representative surgical training model connected with a neural monitoring system.

### DESCRIPTION OF THE ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any such alterations and further modifications in the illustrated devices and described methods, and any such further applications of the principles of the invention as illustrated herein are contemplated as would normally occur to one skilled in the art to which the invention relates.

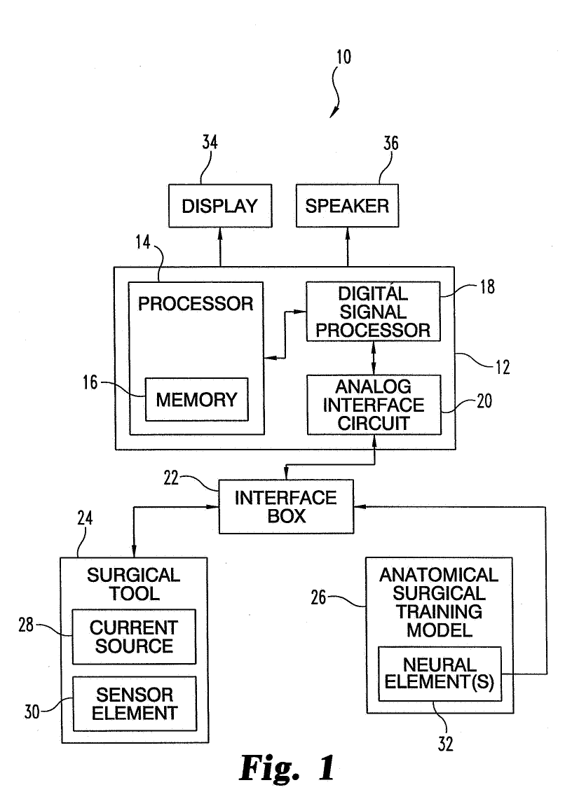

Referring to FIG. 1, a representative simulated neural monitoring system 10 is illustrated that includes a medical device or surgical tool and associated equipment arranged to provide medical training for surgeons performing operations on portions of anatomy containing nerves. System 10 includes a processing unit 12 for receiving a plurality of electric signals generated by various components of system 10. In one form, processing unit 12 includes a microprocessor 14, memory 16, a digital signal processor (“DSP”) 18, and an analog interface circuit 20. Microprocessor 14 can be comprised of one or more components of any type suitable to operate as described herein. Microprocessor 14 is utilized to execute software configured to perform the functions described herein. In one form, the software utilized by system 10 is stored in memory 16.

Memory 16 is illustrated in association with microprocessor 14; however, memory 16 can be separate from microprocessor 14. Memory 16 is utilized to store various parameters monitored by system 10 and can also be used to store software used by system 10 during a surgical training procedure. Memory 16 can be of a solid-state variety, an electromagnetic variety, an optical variety, or a combination of these forms. In addition, memory 16 can be volatile, non-volatile, or a mixture of these types. In some forms, memory 16 can be partially associated with DSP 18 or analog interface circuit 20. Memory 16 can also partially be comprised of a removable memory device such as a floppy disc, a cartridge, a removable hard disc, a tape, an optical disc such as a writeable CD or DVD, a flash drive, or any other type of removable memory device as would occur to those skilled in the art.

As illustrated, in one form microprocessor 14 is connected with DSP 18, which in turn, is connected with analog interface circuit 20. DSP 18 comprises a specifically designed microprocessor designed for processing digital signals. In one form, analog interface circuit 20 comprises an analog to digital (“A/D”) converter configured to convert one or more analog electric signals received from an interface box 22. Although a DSP 18 is used in one form, it should be appreciated that other digital processing circuitry can be used in other forms. In addition, although analog interface circuit 20 comprises an A/D converter in one form, it should also be appreciated that other types of analog circuits can be used in other forms. In yet other forms, a surgical tool or surgical device 24 and at least one neural element 32 of an anatomical training model 26 can be directly connected to processing unit 12.

In one form, interface box 22 is connected with surgical tool 24 and surgical training model 26. Surgical tool 24 can comprise a probe (e.g.—a pedicle probe, a stim control ball-tipped probe), a stimulator (e.g.—a pedicle stimulator), a drill, a screw or bolt driver, a clamp, a retractor, a spreader, or any other type of surgical device that is utilized during surgical procedures near nerves. For example, an illustrative probe that can be utilized with system 10 is disclosed in U.S. patent application Ser. No.: 11/047,357 filed on Jan. 31, 2005 entitled “Electrically Insulated Surgical Probing Tool” which is hereby incorporated by reference in its entirety. In one form, surgical tool 24 includes a current source 28 and/or a sensor element 30. As set forth in detail below, during a surgical training procedure, surgical tool 24 is used to sense when surgical tool 24 or a surgical implant device, such as a bone screw for example, is in close proximity or in contact with a respective neural element 32 in model 26.

Surgical training model 26 comprises an anatomical model of a portion of a mammal, which comprises a human in the forms disclosed herein. For example, in one form, model 26 comprises a portion of the torso of a human. As set forth in greater detail below, model 26 includes one or more neural elements 32 that are configured to mimic or simulate nerves in a particular portion of the human body that model 26 is designed to represent. As such, in one form, such as where surgical training model 26 is designed to mimic a portion of the human torso, the one or more neural elements 32 represent at least a portion of the spinal cord and its associated nerves.

As known to those skilled in the art, the spinal cord is a long, thin, tubular bundle of nerves that is an extension of the central nervous system from the brain and is enclosed in and protected by a bony vertebral column. The main function of the spinal cord is transmission of neural inputs between the peripheral nervous system and the brain. In one form, model 26 is configured and arranged as a portion of the body that contains one or more segments or portions of the central nervous system and/or peripheral nervous system. For example, model 26 can take the form of portions of the human anatomy that contain neural elements 32, in conjunction with other anatomical structures found in those areas of the body such as bones and soft-tissue, that are configured to mimic the brain, cerebellum, brachial plexus, intercostal nerves, musculocutaneous nerves, radial nerves, subcostal nerve, median nerve, lumbar plexus, iliohypogastric nerve, lumbar plexus, sacral plexus, genitofemoral nerve, femoral nerve, obturator nerve, pudendal nerve, ulnar nerve, sciatic nerve, muscular branches of femoral nerve, saphenous nerve, tibial nerve, common peroneal nerve, deep peroneal nerve, and superficial peroneal nerve, to name a few.

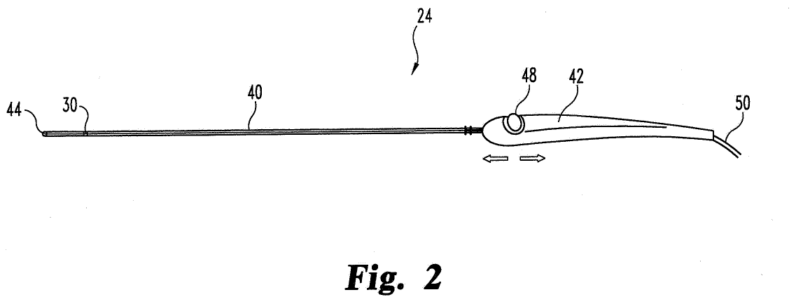

Referring to FIG. 2, an illustrative surgical tool 24 that is utilized with system 10 is depicted. In this form, surgical tool 24 comprises an elongate member 40 removably coupled to a handle assembly 42. In one form, elongate member 40 includes an electrically conductive tip or element 44 located at a distal end of elongate member 40. In another form, elongate member 40 includes one or more sensor elements 30 (see FIG. 1), in addition to or instead of electrically conductive element 44, located at a distal end of elongate member 40. In this representative form, an adjustment member 48 is located on handle assembly 42 that allows adjustment of the amount of electrical current that can be supplied to conductive element 44. For example, adjustment member 48 can be adjusted to allow electrically conductive element 44 to be capable of providing an amount of current ranging from zero milliamps to a predetermined upper limit (e.g. −0 mA-20 mA). A flexible electrical cable 50 containing a plurality of electric wires is used to connect surgical tool 24 to interface box 22. However, in other forms surgical tool 24 can be driven by battery power thereby eliminating the need for cable 50.

As set forth in detail below, in one form interface box 22 is capable of providing electrical current to conductive element 44 of surgical tool 24 via cable 50. In yet another form, as illustrated in FIG. 1, surgical tool 24 includes current source 28 that is configured to provide current to conductive element 44. In this form, current source 28 comprises a battery such as a rechargeable lithium ion battery. During operation, conductive element 44 is configured to induce a flow of current in neural element 32 of model 26 when conductive element 44 comes into contact with neural element 32. This flow of current is sensed by interface box 22 and, in one illustrative form, converted or conditioned into a predetermined analog signal that is transmitted to analog interface circuit 20.

Analog interface circuit 20 converts the analog input signal into a digital signal that is sensed by DSP 18. In other forms, DSP 18 can include an A/D converter thereby eliminating the need for analog interface circuit 20. Software stored in memory 16 instructs processor 14 to obtain readings from DSP 18 and converts these readings into a graphical representation of a simulated response or stimulation of neural elements 32 that is displayed on a display 34 connected with processing unit 12. In addition, in other forms processing unit 12 is connected with a speaker 36 that is configured to produce audible indications indicative of a simulated stimulation of neural elements 32. As such, system 10 mimics or simulates a real-life neural integrity monitoring system that allows surgeons to directly monitor a patient's nerve and/or spinal cord function. In one form, software of processing unit 12 can provide two types of simulated neural monitoring modalities, which comprise electromyographic (“EMG”) and triggered EMG (“tEMG”). As such, processing system 12 is configured and programmed to generate simulated outputs on display 34 and speaker 36 that are equivalent to those produced by EMG and tEMG systems during real surgeries.

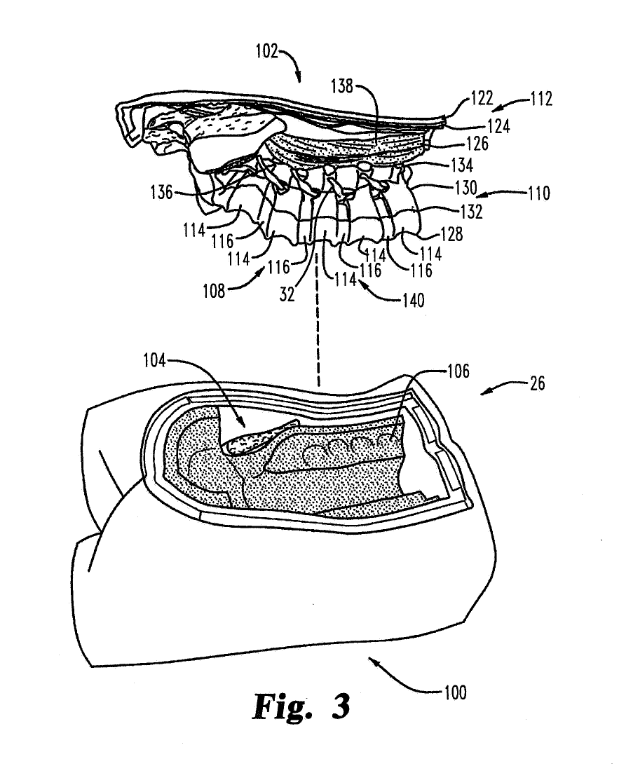

Referring to FIG. 3, an illustrative surgical training model 26 is depicted that includes a holder member 100 and an insert member 102. Holder member 100 includes a receptacle portion 104 configured to receive insert member 102. The shape of insert member 102 at least partially mates with at least one inner surface 106 of receptacle portion 104 when insert member 102 is placed within receptacle portion 104. Following insertion of insert member 102 into receptacle portion 104, the exterior appearance of holder member 100 closely resembles the posterior aspect of a lower torso of a human body.

In one form, insert member 102 is held in place within receptacle portion 104 by material friction or a friction fit, although it should be understood to those skilled in the art that other securement mechanisms are contemplated including, but not limited to Velcro, removable and/or fugitive adhesives and mechanical means. As seen in FIG. 3, the concave receptacle portion 104 of holder member 100 is sized and shaped to accommodate the exterior shape of insert member 102. When assembled, model 26 allows a medical practitioner to perform surgical procedures utilizing what is known in the art as a posterior lumbosacral approach.

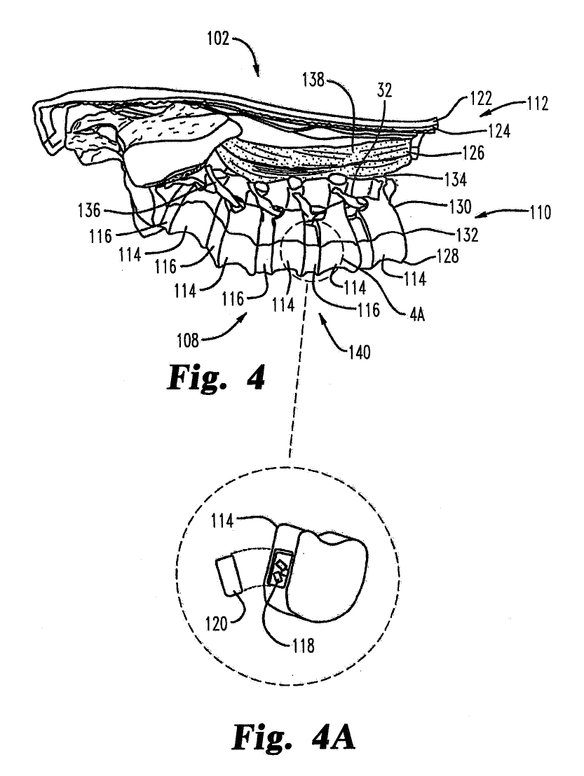

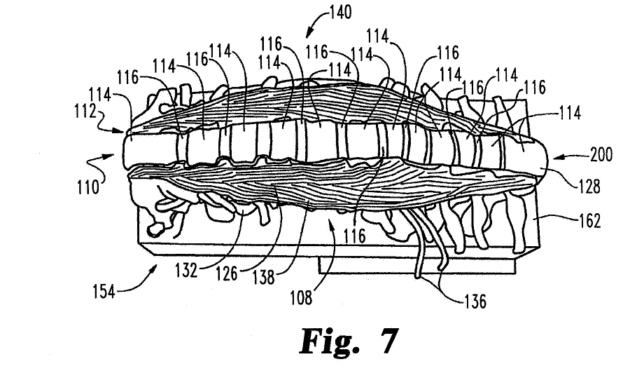

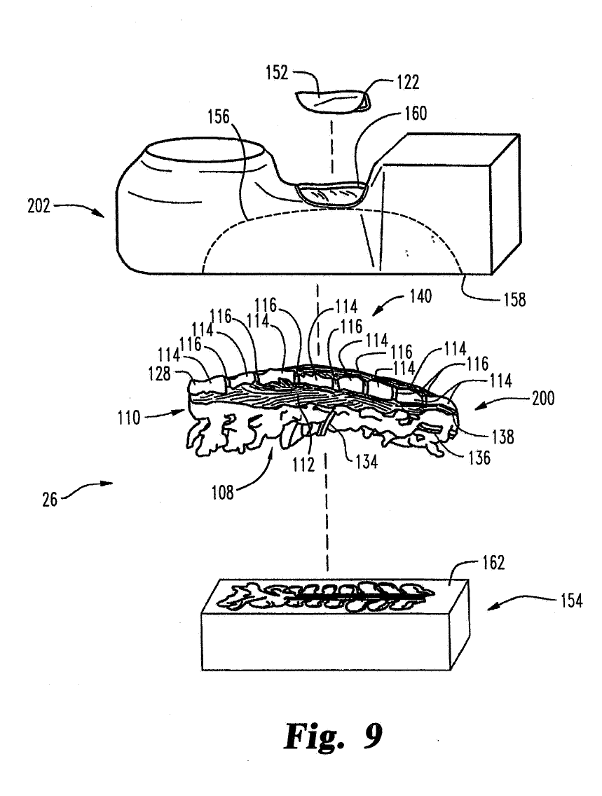

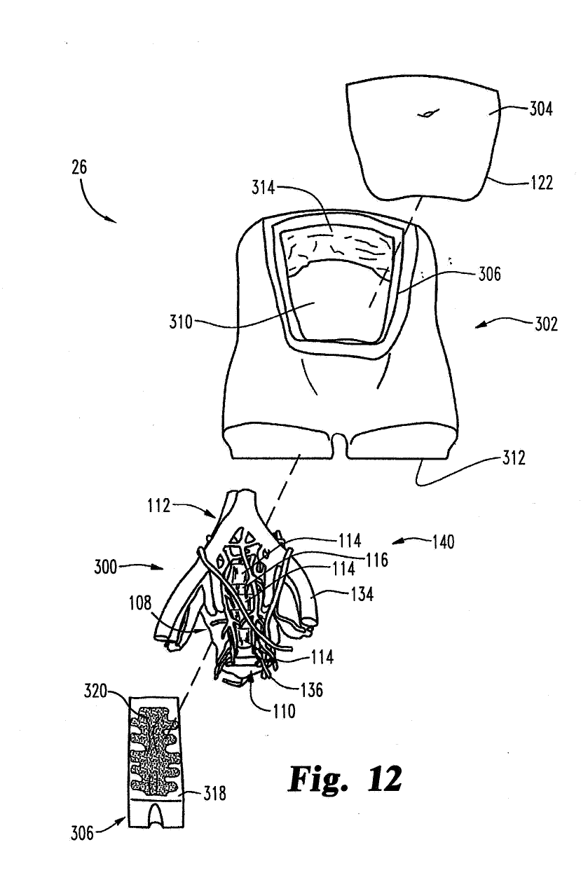

As shown in FIG. 3, 4, 7, 9, and 12, insert members 102, 200, 300 include a replica of a human vertebral column 108. Although the human vertebral column 108 is discussed in great detail as it relates to the present invention, it should be appreciated that the present invention has application in a variety of areas of the human body. The representative vertebral column 108 exhibited in FIGS. 3 and 4 comprise a segment that mimics the human lumbar spine and sacral spine segments. Vertebral column 108 exhibited in FIGS. 7 and 9 comprise a segment that mimics the cervical spine and the vertebral column 108 illustrated in FIG. 12 comprises a segment that mimics a lumbosacral spine segment. It should be understood to those skilled in the art that one or more spine segments, or the entire spine for that matter, can be replicated and utilized instead of insert members 102, 200, 300 depicted herein. These may include the cervical-thoracic spine, the thoracic spine and the sacral-coccyx junction segment. In addition, although spinal models 26 are illustrated in the representative forms disclosed in the description that follows and the figures, it should be appreciated that other portions of the human body can be modeled using the system 10 disclosed herein such as, for example, shoulders, arms, hands, legs, knees, and so forth.

The anatomical portion of the human body, in this form vertebral column 108, includes an artificial bone portion 110 and an artificial soft-tissue portion 112. Artificial bone portion 110 includes one or more vertebral body elements 114 with intervertebral disc elements 116 positioned between each of vertebral body elements 114. It should be understood to those skilled in the art that vertebral body elements 114 can also be referred to as a vertebra or vertebrae (if multiple) and may be comprised of several additional structures, including but not limited to facets, facet capsules, transverse processes, spinous processes, lamina, and pedicles. Vertebral body elements 114 can be fabricated from a polymeric material formulated to mimic real bones. Examples of such polymeric material include polyethylene, polystyrene and acrylic. Based on the therapeutic intervention or solution taught and the procedural anatomy addressed, incremental fixed or modular anatomic model elements can be introduced with a capacity to manage and contain fluids or other media; measure kinematics/biomechanics that may be monitored and directed by changes in viscosity, interstitial and other pressures, volumetric fill, flow dynamics and temperature; anatomic alignment, correction, range of motion.

In one form, the fabrication method utilized to manufacture vertebral body elements 114 include various pressure and temperate ranges that allow for the formation of two regions within vertebral body elements 114. The resulting regions can include a bone shell portion that exhibits physical properties substantially similar to those of normal, diseased, or compromised cortical bone and likewise a bone core portion that has physical properties that are close to human cancellous bone, including a range of pathologies like osteoporosis, hemangioma, tumor, fracture and necrosis. In addition, a radiological illuminating material or additive can be incorporated during the fabrication method of vertebral body elements 114 that results in enhanced radiography of artificial bone portion 110. As such, radiographs will more clearly show artificial bone portion 110 relative to its anatomic position within model 26.

Intervertebral disc elements 116 can be fabricated from an elastomer material configured to mimic normal, diseased, or compromised disc elements. Examples of such elastomeric material include urethane, rubber, silicone and polyolefin. Intervertebral disc elements 116 are generally manufactured utilizing a process that results in a nucleus portion 118 and an annulus portion 120 (see FIG. 4A) each having a Shore A hardness range of about 5 to 90 A, with a more detailed range being of about 10 to 20 A. Those skilled in the art should recognize that other Shore A hardness's may be utilized in other forms.

As seen in FIGS. 3, 4, 7, 9 and 12 artificial soft-tissue portion 112 is a matrix-like structure which includes closely placed layers of various structural elements. Such structural elements can be colored or dyed in a manner to provide the user of model 26 with the ability to identify individual anatomic features of insert members 102, 200, 300 specifically within the vicinity of the surgical site. The various structural elements that comprise artificial soft-tissue 112 can include an outer skin element 122, a subcutaneous tissue or fascia element 124, several different muscle elements 126, an anterior ligamentous structure element 128, a posterior ligamentous structure element 130, lateral oriented ligamentous elements 132, vascular elements 134 including veins and arteries, and tethered nerve root elements 136. It should be appreciated that other structural elements are included in other artificial soft-tissue portions 112 of the human body.

Artificial soft-tissue portion 112 can be manufactured from an elastomeric material. Examples of elastomeric materials that can be used include urethane, silicone and polyolefin. The manufacturing process for producing artificial soft-tissue portion 112 generally results in producing elements with varying Shore A hardness values. For illustrative purposes only, the dura mater, subcutaneous and fascia elements 124 can have a value range of about 5 to 90 A, with a more detailed example being a range of about 15 to 25 A. Skin element 122 can have a range of 10 to 20 A and muscle element 126 can have a range of about 10 to 90 A. The ligamentous structure elements 128, 130, 132 can have a range generally from about 5 to 90 A, with a more detailed range being about 15 to 25 A. The vascular and nerve elements 134, 136 can have a range from about 5 to 90 A, with a more specific example being a range of about 10 to 20 A.

Muscle element 126 incorporates into its outer structure numerous cuts or striations 138 that mimic the natural plane angles seen in human skeletal muscles. Striations 138, in combination with the elastomeric material used to fabricate muscle element 126, provide the user of model 26 with the look and feel of a skeletal muscle in-vivo. This look and feel characteristic includes the natural lubrication phenomena experienced by a medical practitioner when a muscle structure is cut in situ. In practice, muscle element 126, in combination with at least one of the other above listed soft-tissue elements 122, 124, 128, 130, 132, 134 that comprise artificial soft-tissue portion 112, are oriented and positioned relative to each other to achieve an aggregate resistance to surgical manipulation that is substantially the same resistance a medical practitioner would experience when cutting or retracting soft tissue structures that surround the human spinal column or other bone structures during an operative procedure.

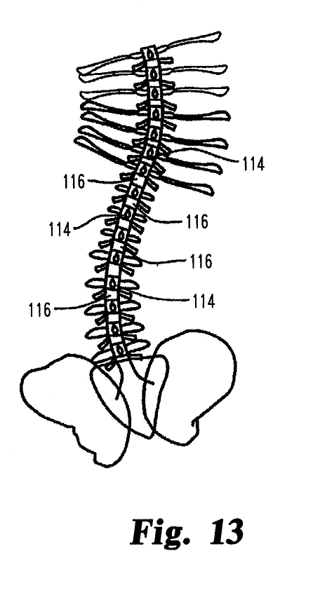

Each insert member 102, 200, 300 will usually include an addition to artificial bone portion 110 and artificial soft tissue portion 112, which comprises a pathology structure 140 (i.e.—a diseased or damaged structure). In the forms illustrated herein, pathology structure 140 can include at least one vertebral body 114 and/or at least one intervertebral disc element 116. Each pathology structure 140 can be constructed to replicate an actual disease or abnormal structural state that a user may be presented with clinically. For illustrative purposes only, in model 26 one or more vertebral bodies 114 can be structurally modified to replicate the clinical conditions of degenerative osteophyte formation, osteoporosis, congenital malformations, injury from trauma or spondylolisthesis. As generally illustrated in FIG. 13, vertebral bodies 114 can also be structurally modified to exhibit clinical skeletal deformities similar to anterior, posterior and lateral stenosis, kyphosis, scoliosis and Scheuermann disease.

Intervertebral disc elements 116 can be structurally modified to replicate various structural or disease based pathologies including, but not limited to, disc degeneration, disc collapse, disc rupture and disc slippage. As shown in FIG. 4A, intervertebral disc element 116 of pathology structure 140 can be constructed to include annulus portion 120 and nucleus portion 118. As discussed previously herein, annulus portion 120 and nucleus portion 118 can be fabricated from an elastomer material. In combination, annulus portion 120 and nucleus portion 118 can mimic the physical characteristics of a degenerative human disc. Nucleus portion 122 generally has a composite-like structure that can include multiple imbedded particulates or polygonal bodies. Depending upon the fabrication process, the composite-like structure allows the medical practitioner to experience various degenerative states of intervertebral disc element 116 while placed within pathology structure 140 during the performance of a simulated surgical procedure.

As previously set forth, it is important to reiterate that although various spinal models 26 are illustrated in the representative forms depicted herein; other portions of the human body can be modeled and utilized in conjunction with system 10. For example, if a patient needs to undergo reconstructive knee surgery, it may be advantageous to train surgeons using a model 26 that contains neural elements 32 found in the knee. This training will prepare surgeons so that they can avoid damaging, pinching, or otherwise adversely affecting neural elements 32 contained in the knee.

As depicted in FIGS. 3, 9 and 12, in some forms insert members 102, 200, 300 are configured to be modular in design relative to each respective holder member 100, 202, 302. Thus, a user may interchange various insert members 102, 200, 300 having different pathologies with a holder member 100, 202, 302. In practice, because of the modular design, a user can choose from a wide selection of insert members 102, 200, 300 and corresponding integral pathology structures 140 to customize and construct a surgical training model that represents a certain clinical situation. For example, a user may want to choose a respective insert member 102, 200, 300 and corresponding pathology structure 140 that is constructed to replicate a ruptured disc. Because the insert members 102, 200, 300 are modular, an insert member 102, 200, 300 that includes a pathology structure 140 with a ruptured disc can readily be exchanged with a respective insert member 102, 200, 300 that has a different pathology structure that is not desired by the user. The modular design of insert members 102, 200, 300 allow the user to utilize one respective holder member 100, 202, 302 with multiple, separate insert members 102, 200, 300 that have the desired pathology structure 140.

Generally, insert members 102, 200, 300 are discarded following the performance of a surgical training procedure, though it is contemplated that insert members 102, 200, 300 and pathology structures 140 could be reused for multiple training surgeries. It should be understood to those skilled in the art that a one piece model 26 is contemplated for all of the forms of the models 26 described herein, wherein each holder member 100, 202, 302 and insert member 102, 200, 300 can be constructed from a single unitary body with distinct anatomic elements being exchanged following the performance of a surgical procedure or alternatively, the entire unitary body can be exchanged or discarded following the completion of the surgical training session.

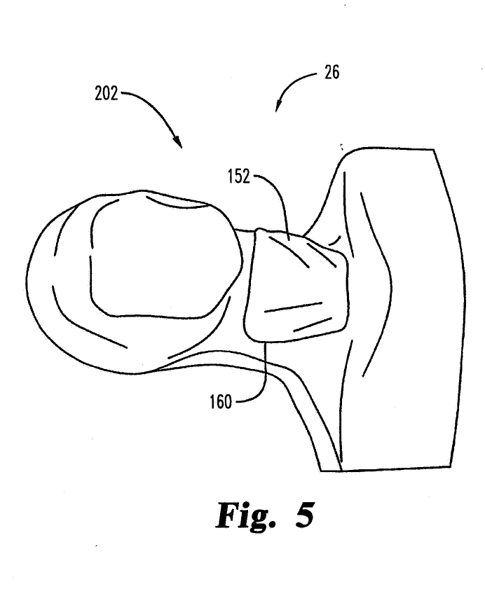

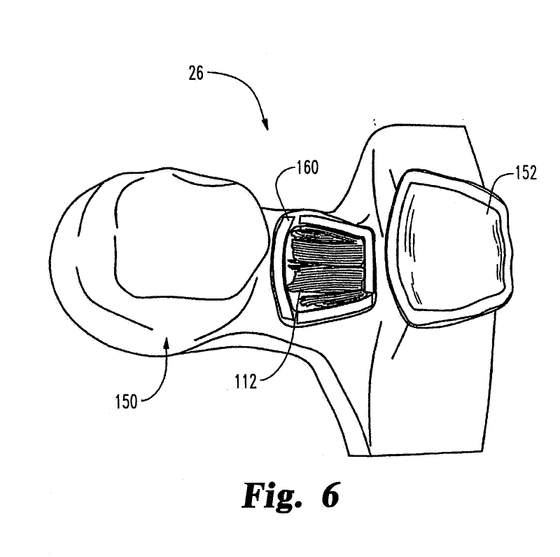

FIG. 5 shows another representative form of model 26 having a holder member 202 and a skin flap 152 in place on model 26. As depicted in FIG. 9, model 26 includes holder member 202, an insert member 200, a cradle 154 and skin flap 152. The form of model 26 depicted in FIGS. 5, 6 and 9 allows the medical practitioner to perform surgical procedures utilizing what is known in the art as an anterior cervical approach to gain access to the anterior aspect of the cervical spine. As seen in FIGS. 5 and 6, such access is gained by making a surgical incision along the anterior aspect of the neck through skin flap 152. The medical practitioner can then dissect the various neck structures and associated artificial soft-tissue portions 112 until the anterior portion of the cervical spine is exposed.

Holder member 202 includes a receptacle portion 156 on a back surface 158 of holder member 202 that is shaped and sized to receive insert member 200 and cradle 154. The outside configuration of insert member 200 partially mates within at least one inner surface of receptacle portion 156 when insert member 200 is placed within receptacle portion 156. Following the placement of insert member 200 and cradle 154 into receptacle portion 156, the exterior appearance of holder member 202 closely resembles the head, neck and upper torso of a human body (see FIG. 5). As shown in FIG. 6, following placement of insert member 200 into the receptacle portion 156, artificial soft-tissue portions 112 is visible through a neck port 160.

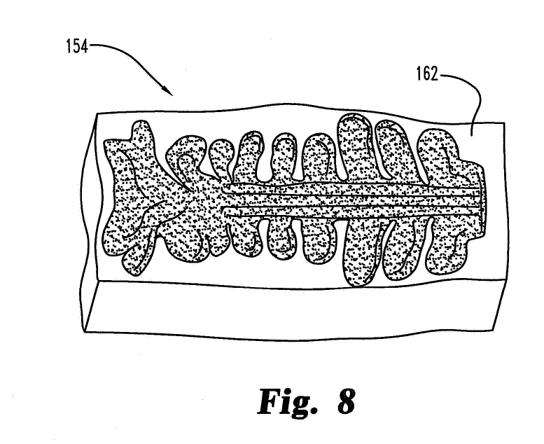

As shown in FIG. 9, insert member 200 is held in place within receptacle portion 156 by coupling to supporting cradle 154. FIG. 7 shows insert member 200 positioned proximate to top surface 162 of cradle 154 with cradle 154 providing structural support and stability to insert member 200 when the insert member-cradle assembly is placed within the receptacle portion 156 of holder member 202. Cradle 154 is typically fabricated from an elastomer or polymeric material. The material ultimately chosen depends upon the desired stiffness of insert member 200 and pathology structure 140 that is utilized. As depicted in FIG. 8, cradle 154 can have several concavities on top surface 162 that generally correspond with the exterior topography of artificial bone portion 110 and soft tissue portion 112 of insert member 200. Insert member 200 and cradle 154 can be frictionally coupled, although it should be understood to those skilled in the art that other coupling mechanisms are contemplated including, but not limited to Velcro, removable adhesives and mechanical means.

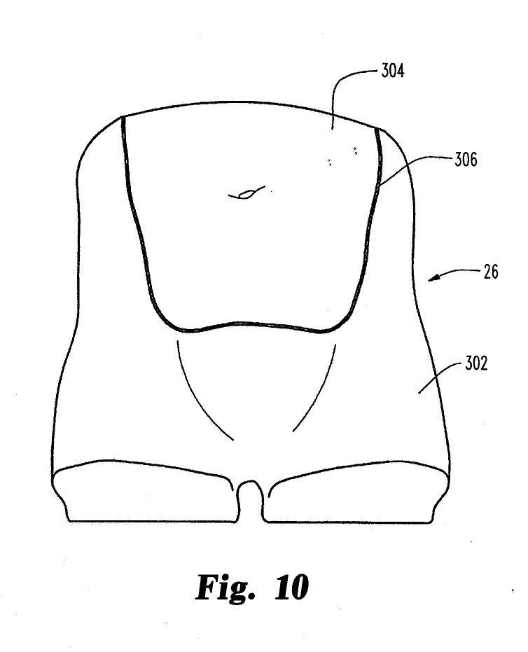

FIGS. 10, 11, and 12 depict yet another form of a model 26 that is utilized in connection with system 10. Specifically, FIG. 10 shows model 26 including a holder member 302 and a skin flap 304 positioned within an abdominal port 306. As seen in FIG. 12, model 26 includes holder member 302, insert member 300, a cradle 306 and skin flap 304. The form of surgical training model 26 shown in FIGS. 10, 11, and 12 provides the medical practitioner with the ability to perform surgical procedures utilizing what is known in the art as an anterior abdominal approach to gain access to the anterior aspect of the lumbosacral spine segment.

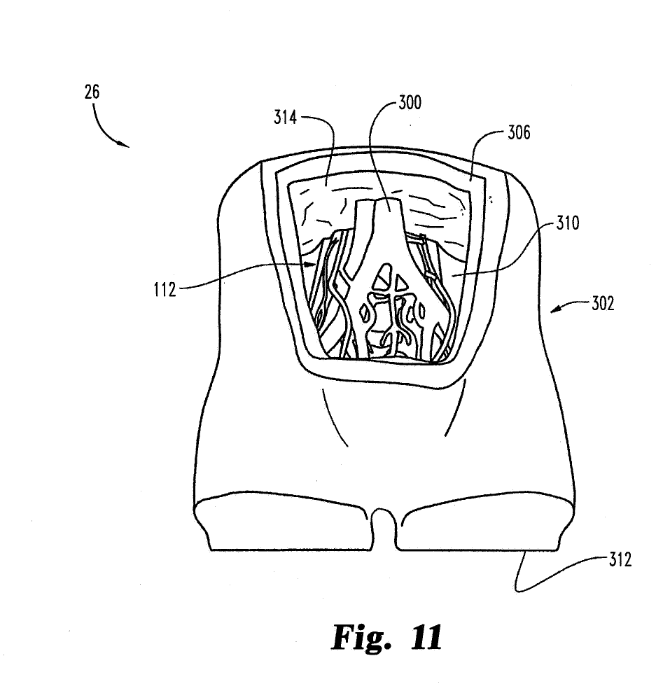

As depicted in FIGS. 10 and 11, such access is gained by making a surgical incision on the anterior aspect of the abdomen through skin flap 304. The medical practitioner can then dissect around the various abdominally-located organs, vascular structures and other associated soft-tissue portions 112 until the anterior portion of the lumbosacral spine is exposed. Holder member 302 includes a receptacle portion 310 located within a back surface 312 of holder member 302 that is configured to receive insert member 300 and cradle 306. As seen in FIG. 12, following placement within receptacle 310, the external configuration of insert member 300 contacts at least one inner surface 314 of receptacle portion 310 when insert member 300 is placed within receptacle portion 310. Following the placement of the insert member-cradle assembly into receptacle portion 310 and the placement of skin flap 304 over the abdominal port 306, the exterior appearance of holder member 302 closely resembles the lower abdominal region of a human body. As shown in FIG. 11, after the insert member-cradle assembly is placed within the receptacle portions 310, artificial soft tissue portion 112 is visible through abdominal port 306 after skin flap 304 is cut and removed from holder member 302.

As depicted in FIG. 12 and described previously herein, insert member 300 is held in place within receptacle portion 310 by coupling to supporting cradle 306 or alternatively, insert member 300 is integral to cradle 306. Generally, insert member 300 is proximate to the top surface 318 of cradle 306. Cradle 306 functions to provide structural support and stability to insert member 300 when the insert member-cradle assembly is placed within receptacle portion 310 of holder member 302. The support, stiffness and stability provided by cradle 318 in conjunction with insert member 300 is necessary in order for model 26 to provide the realistic surgical feel that the medical practitioner is seeking when utilizing model 26 as part of system 10.

In one form, cradle 306 is fabricated from an elastomer or polymeric material. The material ultimately chosen for cradle 306 construction depends upon the desired stiffness of insert member 300 and pathology structure 140 that will be utilized. Generally, as described previously herein, cradle 306 has concavities on a top surface 318 that correspond with the external topography of artificial bone portion 110 and many also match that of soft tissue portion 112 of insert member 300 as shows in FIG. 12. Insert member 300 and cradle 306 are frictionally coupled together, although it should be understood to those skilled in the art that other coupling mechanisms are contemplated including, but not limited to Velcro, removable adhesives and mechanical means. Although not shown, it is contemplated that for model 26, the insert member-cradle assembly can be a unitary one-piece construct.

It is further contemplated that an alternative to the multiple modular configurations described herein for models 26, a one piece apparatus can be utilized for the holder member and insert member. Although not shown, it should be understood to those skilled in the art that a modular pathology structure can be used with a one piece holder-insert apparatus. Further, it is also contemplated that a single structure can be used and will incorporate all elements of the holder, insert and pathology structure, thereby allowing the user to dispose of the single piece structure following the performance of a surgical procedure.

The illustrative models 26 disclosed herein can also be available as a system, wherein the system includes a single holder member and a plurality or series of different insert members and if appropriate, a corresponding plurality of cradles. It should be understood to those skilled in the art that each of the plurality of insert members can include one or more different pathology structures. The system, because of the modular relationship between the holder members and the insert members, allows the medical practitioner to typically use one holder member and obtain multiple insert members with corresponding multiple and different pathology structures as has been previously described herein. This system provides the medical practitioner with several clinical presentations as replicated by the corresponding pathology structures on which to train in a single setting.

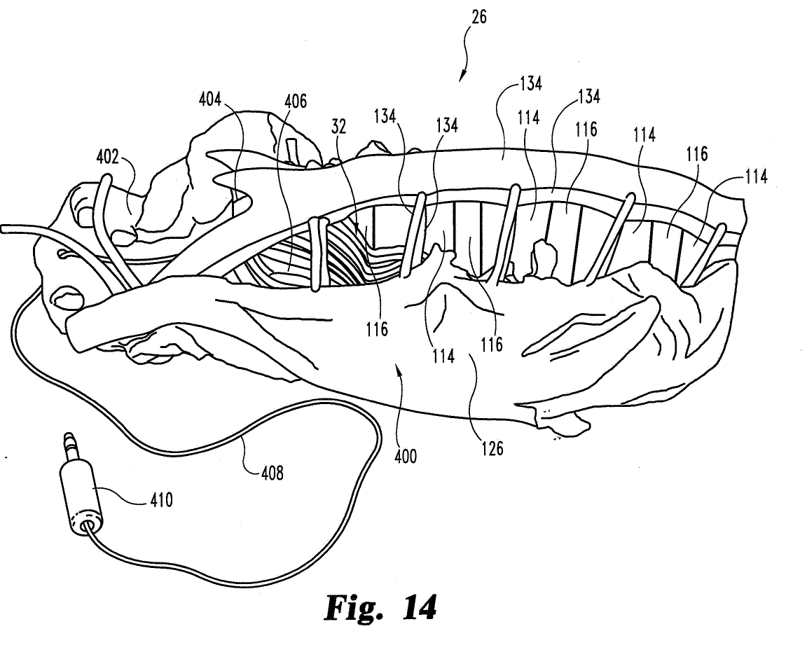

Referring to FIG. 14, a portion of another form of model 26 is illustrated that comprises an insert member 400 that includes a plurality of simulated neural elements 32. As illustrated, insert member 400 includes a plurality of vertebral body elements 114 with intervertebral disc elements 116 positioned between each of vertebral body elements 114. Insert member 400 also includes a muscle element 126 that is connected with the vertebral body elements 114 and the intervertebral disc elements 116 as illustrated. In addition, insert member 400 includes a plurality of vascular elements 134, including veins and arteries, which are located at various locations along insert element 400. In this form, insert member 400 also includes a sacrum 402 that is connected with an intervertebral disc element 116.

In this form, one or more neural elements 32 are connected to select portions of vertebral body elements 114 and intervertebral disc elements 116. In particular, neural elements 32 run the entire width or horizontal distance defined by vertebral body elements 114 and intervertebral disc elements 116 and terminates at a predetermined location 404 on sacrum 402. In one form, neural elements 32 comprise a plurality of flexible conductive wires or elements 406 that bend or flex to match the contour or shape of vertebral body elements 114 and intervertebral disc elements 116. As such, in this form neural elements 32 are connected with artificial bone portions 110 (i.e.—vertebral body elements 114 and intervertebral discs 116) and are located beneath select portions of artificial soft-tissue portions 112 (i.e.—muscular element 126 and vascular elements 134).

Referring collectively to FIGS. 1, 2 and 14, during a surgical training procedure, once conductive element 44 of surgical tool 24 makes contact with a respective neural element 32, an electric signal is generated by a respective conductive wire 406 that is transmitted through a respective wire 408 connected with neural elements 32. A connector plug 410 is connected to an end of wire 408 that allows neural elements 32 to be electrically connected with interface box 22.

As previously set forth, conductive element 44 of surgical tool 24 is connected with a current source 28. When conductive element 44 of surgical tool 24 makes contact with a respective neural element 32, current begins to flow through the respective conductive wire 406 that conductive element 44 makes contact with during the training procedure. As a result, the conductive wire or element 406 representing neural element 32 generates an electric signal that is transmitted to interface box 22. Interface box 22 is connected with processing unit 12, which receives the signal generated by the respective neural element 32.

In one form, analog interface circuit 20 conditions or converts the electric signal received from interface box 22 into a form compatible with DSP 18. During operation, microprocessor 14 obtains a reading from DSP 18 indicative of the fact that conductive element 44 of surgical tool 24 has made contact with a respective one of the neural elements 32. As a result, microprocessor 14 is configured to generate a visual representation of contact being made with a neural element 32 via display 34, similar to an EMG response for example, and/or can generate an audible alarm or indication using speaker 36. When conductive element 44 is removed from the respective neural element 32 it is in contact with, the electric signal generated by neural element 32 is no longer present causing processing unit 12 to instruct display 34 and/or speaker 36 to return to a normal operating state in which no neural contact is indicated. A record of each contact made to a respective neural element 44 can be stored in memory 16 for later analysis. As such, during a surgical training procedure neural elements 32 simulate how real nerves react to contact during surgical procedures and allow surgeons to train to avoid making potential harmful contact with nerves during real surgical procedures.

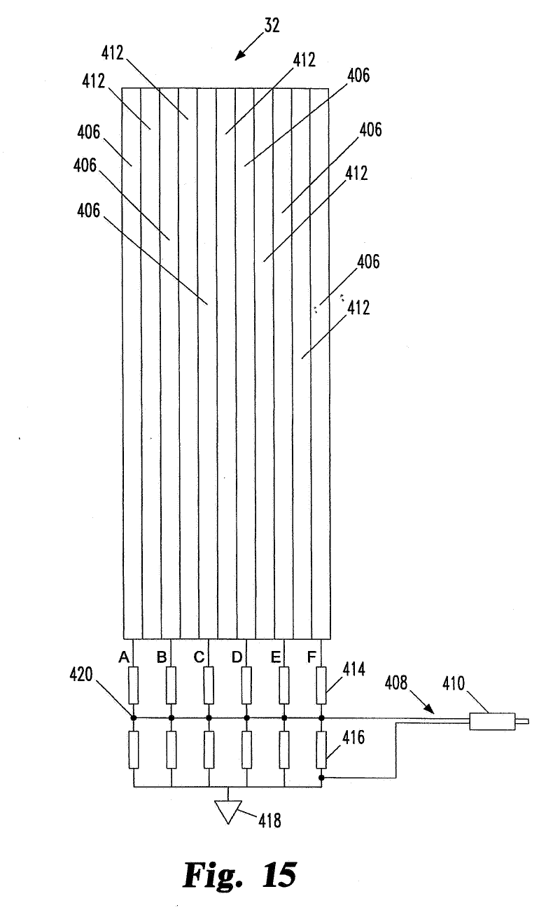

Referring to FIG. 15, in one representative form each neural element 32 comprises a plurality of exposed flexible conductive wires or elements 406 that are separated from one another by a non-conductive material 412. As illustrated, in this form, neural element 32 resembles a ribbon cable. Although the neural elements 32 are illustrated as a unitary structure in this form, it should be appreciated that in other forms one or more individual wires 406 can be pealed or torn away from the unitary structure such that an individual wire 406 can be strategically placed within a respective model 26 to mimic a nerve. As such, each individual wire 406 can be positioned in a respective model 26 to mimic or simulate a respective nerve for that particular portion of the human body. In other forms, individual wires 406 can be utilized in model 26 instead of wires configured in a ribbon cable format.

In another representative form, an end of each respective wire 406 or neural element 32 is connected with a first resistor 414 and a second resistor 416. An end of second resistor 416 is connected with a ground connection 418. As illustrated, the first and second resistors 414, 416 are connected in a series relationship with respect to each other. In this form, the first and second resistors 414, 416 that are connected with each respective wire 406 or neural element 32 have different resistance values. As such, a monitoring wire 420 that is connected with connector plug 410 will transmit different electric signals that correspond to each individual wire 406 of neural element 32 when conductive tip 44 of surgical tool 24 touches a respective wire 406. As illustrated, the other end of monitoring wire 420 is connected between each respective resistor 414, 416 and based on the differing values of resistors 414, 416 will sense different voltage values. For illustrative purposes only, during operation the following voltages might be present on monitoring wire 420 when a respective wire 406, labeled A-F in FIG. 15, is touched by conductive element 44: wire 406A—0.5 V, wire 406B—0.6 V, wire 406C—0.7 V, wire 406D—0.8 V, wire 406E—0.9 V, and wire 406F—1.0 V.

In another form, an end of each respective wire or element 406 or neural element 32 is connected with a resistor 414 and the other end of resistor 414 is connected with a ground connection 418. In this form, each resistor 414 has a different resistance. As previously set forth, surgical tool 24 is operable to provide a predetermined amount of current to element 406 when conductive member 44 comes into contact with element 406. Since the voltage generated across resistors 414 is a function of current and resistance and each resistor 414 has a different resistance value, the amount of voltage generated across resistors 414 by the stimulus or current provided by conductive member 44 to will vary from element 406 to element 406. As such, in this form, monitoring wire or element 420 will have different voltage values present for each respective element 406.

As previously set forth, these respective electric signals are transmitted to interface box 22 and then on to processing unit 12. In this form, processing unit 12 is not only configured to determine whether or not a simulated nerve has been touched, but what specific simulated nerve has been touched by surgical tool 24. In some surgical models 26, a plurality of wires 406 (representing individual neural elements 32) are spread throughout the artificial bone portions 110 and artificial soft-tissue portions 112. This form allows system 10 not only to determine that a respective simulated nerve in model 26 has been touched, but exactly what nerve amongst a plurality of nerves in model 26 has been touched. Processing unit 12 is configured to generate a visual display of the respective nerve that was touched on display 34. As with other forms, an audible alarm can also be generated using speaker 36.

In alternative forms, the range of voltages can be used by processing unit 12 to indicate to the surgeon that surgical tool 24 is getting closer to a respective nerve that is being simulated by neural element 32. For example, as surgical tool 24 travels deeper into model 26 during the training procedure, conductive element 44 of surgical tool 24 will successively make contact with each respective wire 406 one at a time. A visual indication of the fact that the surgeon is getting near a nerve can be displayed on display 34 and an audible alarm having a predetermined frequency rate can be generated on speaker 36. As the surgeon continues to work, the visual indication on display 34 can indicate a greater level of urgency or closeness and the frequency at which the audible alarm is played on speaker 36 can increase until a maximum alarm rate is reached indicating that the nerve has actually been contacted or touched by conductive element 44 of surgical tool 24.

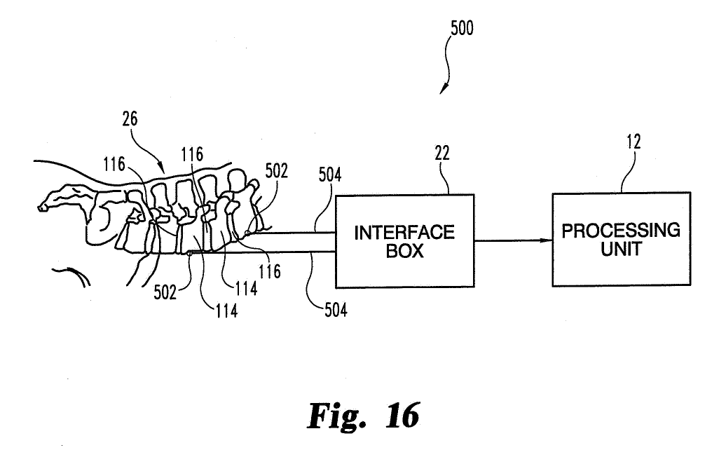

Referring to FIG. 16, a portion of another representative system 500 is illustrated that utilizes a plurality of proximity sensors 502. As illustrated, at least one or more proximity sensors 502 are connected to a respective artificial bone portion 110, which in this illustrative form comprises vertebral bodies 114. Referring collectively to FIGS. 1, 2, and 16, in some forms surgical tool 24 includes a sensor element 30. As sensor element 30 approaches one or more of the proximity sensors 502, an electrical signal is sent via wire 504 to interface box 22. In one form, the closer sensor element 30 gets to a respective proximity sensor 502, the stronger the electric signal generated by proximity sensor 502 gets. As such, as sensor element 30 of surgical tool 24 gets closer to the proximity sensor 502, a corresponding signal is sent via wire 504 to interface box 22 which would cause processor unit 12 to generate a display on display 34 indicating that the surgical tool 24 was approaching, or in some cases, has actually touched a nerve, which is represented by proximity sensor 502. In other forms, proximity sensor 502 operates in a binary format to indicate that a nerve is either in a “detected or touched state” or “non-detected or not touched state.” Proximity sensor 502 can comprise an inductive proximity sensor, a capacitive proximity sensor, an optical proximity sensor, a radio frequency proximity sensor, a magnetic proximity sensor, or any other type of suitable proximity sensor.

Although the preferred embodiments have been depicted and described in detail herein, it will be apparent to those skilled in the art that various modifications, additions and substitutions can be made without departing from its essence and therefore these are to be considered to be within the scope of the following claims.

What is claimed is:

1. A surgical training apparatus, comprising:
an artificial bone portion configured to mimic at least a portion of an anatomy of a mammal;
an artificial soft-tissue portion surrounding at least a portion of said artificial bone portion configured to mimic said portion of said anatomy of said mammal; and
a neural element oriented in relation to said artificial bone portion and said artificial soft-tissue portion to mimic a respective nerve located in said portion of said anatomy of said mammal and further being operable to generate an electric signal in response to a stimulus.

2. The surgical training apparatus of claim 1, where said neural element comprises at least one electrically conductive element.

3. The surgical training apparatus of claim 1, where said neural element comprises a proximity sensor.

4. The surgical training apparatus of claim 3, where said proximity sensor is selected from a group of proximity sensors comprising an inductive proximity sensor, a capacitive proximity sensor, an optical proximity sensor, a radio frequency proximity sensor, and a magnetic proximity sensor.

5. The surgical training apparatus of claim 1, where said neural element comprises a ribbon cable having a plurality of flexible electrically conductive elements.

6. The surgical training apparatus of claim 1, where said neural element comprises an electrically conductive element connected with a pair of resistors configured to generate a voltage in response to said stimulus.

7. A surgical training model, comprising:
a holder member having a receptacle portion;
an insert member configured to be positioned within said receptacle portion of said holder member and configured to mimic a portion of an anatomy of a mammal; and
at least one neural element oriented to mimic at least one nerve located in said portion of said anatomy of said mammal, where said at least one neural element is configured to generate an electric signal in response to a stimulus.

8. The surgical training model of claim 7, further comprising an electrical cable having a first end connected with said at least one neural element and a second end connected with a connector plug for interfacing with a monitoring system.

9. The surgical training model of claim 7, where said neural element comprises a plurality of electrically conductive elements.

10. The surgical training model of claim 7, where said neural element comprises a ribbon cable.

11. The surgical training model of claim 7, where said neural element comprises a plurality of electrically conductive elements oriented to mimic a plurality of nerves located in said portion of said anatomy of said mammal.

12. The surgical training model of claim 11, where an end of each respective one of said plurality of electrically conductive elements is connected with a respective resistor.

13. The surgical training model of claim 12, where each respective resistor has a different resistance.

14. The surgical training model of claim 7, where said neural element comprises a proximity sensor.

15. A surgical training system, comprising:
an anatomical surgical training model having an artificial bone portion and an artificial soft-tissue portion surrounding at least a portion of said artificial bone portion, where said artificial bone portion and said artificial soft-tissue portion are configured to mimic at least a portion of an anatomy of a mammal;
a neural element oriented in relation to said artificial bone portion and said artificial soft-tissue portion to mimic one or more nerves located in said portion of said anatomy of said mammal;
a surgical device operable to cause said neural element to generate an output signal in response to the presence of said surgical device; and
a processing unit connected with said neural element for receiving said output signal.

16. The surgical training system of claim 15, further comprising a display connected with said processing unit for displaying a graphical display of said output signal.

17. The surgical training system of claim 15, further comprising an interface box connected with said surgical device, said neural element, and said processing unit.

18. The surgical training system of claim 15, where said surgical device includes a current source that causes said neural element to generate said output signal if at least a portion of said current source touches said neural element.

19. The surgical training system of claim 15, where said surgical device includes a sensor element and said neural element comprises a proximity sensor, were said surgical device causes said proximity sensor to generate said output signal if said surgical device is positioned within a predetermined distance of said proximity sensor.

20. The surgical training system of claim 15, where said artificial bone portion and said artificial soft-tissue portion comprise an insert member that is positioned in a receptacle portion of a holding member of said anatomical surgical training model.

21. The surgical training system of claim 15, where said neural element comprises one or more electrically conductive elements.

22. A method of training a surgeon to perform a surgical procedure, comprising:
providing an anatomical surgical training model having an artificial bone portion and an artificial soft-tissue portion surrounding at least a portion of said artificial bone portion, where said artificial bone portion and said artificial soft-tissue portion are configured to mimic at least a portion of an anatomy of a mammal;
providing one or more neural elements that mimic one or more nerves located in said portion of said anatomy of said mammal;
providing a surgical device operable to cause said neural element to generate a signal in response to the detection of the presence of said surgical device; and
generating an indicator if said neural element generates said signal.

23. The method of claim 22, where said one or more neural elements comprise one or more conductive elements.

24. The method of claim 22, where said one or more neural elements comprise one or more proximity sensors.

25. The method of claim 22, where said indicator comprises one of a graphical display generate on a display or an audible warning generated by a speaker.
